(19) United States
(12) Patent Application Publication
(10) Pub. No.: US 2013/0272376 A1
(43) Pub. Date: Oct. 17, 2013

(54) SAMPLE ADAPTIVE OFFSET (SAO) FILTER WITH BOUNDARY INTERPOLATION

(71) Applicant: SONY CORPORATION, Tokyo (JP)

(72) Inventor: Ehsan Maani, San Jose, CA (US)

(73) Assignee: SONY CORPORATION, Tokyo (JP)

(21) Appl. No.: 13/798,032

(22) Filed: Mar. 12, 2013

Related U.S. Application Data
(60) Provisional application No. 61/624,912, filed on Apr. 16, 2012.

(51) Int. Cl. H04N 7/26

(52) U.S. Cl. CPC H04N 19/0089
USPC 375/240.02

(57) ABSTRACT

A boundary interpolation method is described for use with band offsets (BO) and largest coding units (LCU) within a video encoder. In BO, for example, very different offsets could otherwise be added to neighboring pixels which result in large discontinuities and visual artifacts. An interpolation, such as linear, is performed between the BO, or the periphery of the LCU, or a combination thereof, to smooth the offset function toward preventing introduction of visual artifacts.

### CROSS-REFERENCE TO RELATED APPLICATIONS

This application is a nonprovisional of U.S. provisional patent application Ser. No. 61/624,912 filed on Apr. 16, 2012, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to video encoding and decoding, and more particularly to achieving continuity within the sample adaptive offset (SAO) filter within a high-efficiency video coding (HEVC) system, or similar.

2. Description of Related Art

Enhanced video compression techniques are eagerly sought toward optimizing compression. The latest efforts by the Joint Collaborative Team on Video Coding (JCT-VC) of ITU-T and ISO/IEC MPEG aim to support ultra high video resolution and mobile applications while reducing the bitrate compressed in H.264/AVC coding systems, within a high efficiency video coding (HEVC) standard.

HEVC divides frames into coding tree blocks (CTBs) that can be further subdivided into coding units (CUs), such as using quadtree segmentation. A coding unit (CU) may have variable sizes depending on video content toward achieving a desired coding efficiency. CUs typically include a luminance component Y and two chroma components, U and V. The size of U and V components relate to the number of samples, and can be the same or different from that of the Y component, as depends upon the video sampling format. The CUs can be further subdivided into prediction unit (PU) partitions during intra-prediction and inter-prediction as well as transform units (TUs) defined for transform and quantization. Transform units (TU) generally refer to a block of residual data to which a transform is applied when generating transform coefficients.

HEVC introduced new elements over current video coding systems, such as H.264/AVC, and similar codecs. For example, although HEVC still involves motion compensated inter predictions, transforms, and entropy coding, it utilizes either arithmetic coding or variable length coding. In addition, following the deblocking filter is a new sample adaptive offset (SAO) filter. The SAO unit considers the entire frame as a hierarchical quadtree. Quadrants in this quadtree are activated by the SAO transmitting syntax values which each represent an intensity band of pixel values referred to as band offset (BO) or the difference compared to neighboring pixel intensities referred to as edge offset (EO). For each type in SAO (BO and EO), transmitted offset values referred to as SAO offset will be added to the corresponding pixels.

In recent HEVC implementations, the reconstructed image histogram (entire intensity range) is divided into a plurality of bands (e.g., 32 bands), with each band having a different offset. Fewer bands (e.g., 4 bands) are selected by the encoder to be transmitted as offsets. If no offset value is transmitted for a band, then the default value if zero. Band offset (BO) in HEVC transmits offsets for 4 bands of the image histogram which is divided into 32 bands. If a reconstructed pixel value falls in one of the 4 bands, then the offsets are added to the reconstructed value.

Offsets in BO are computed individually based on average performance (mean-square error—MSE). However, the use of average performance is insufficient to assure a visually pleasing picture. Discontinuities at the boundaries between the offsets (e.g., 4 offsets transmitted) should also be avoided in a natural image. Artificial edges are created in an image when two very different offset values are added to two neighboring pixels having similar original values. Edges arising from this issue are especially visible to human eyes in smooth areas of the scene.

Therefore, a method and apparatus are needed for encoding and decoding video using an SAO filter in which artificial edges are not introduced in response to selecting between the limited number of offset bands.

### BRIEF SUMMARY OF THE INVENTION

A sample adaptive offset (SAO) method for HEVC and similar encoders/decoders is taught which utilizes a process of boundary interpolation (BI) for band offsets (BO), largest coding unit (LCU), or a combination of both. Specifically, the boundary interpolation (BI) method of SAO is taught which mitigates introduction of artificial edges in response to the limited number of offsets transmitted. Interpolation at the band boundary generally has a maximum distance d, such as between 4 to 10, and more preferably 6 or 8, as the distance between the two values that have their original offset value. Offset values for other pixels in between the two offset values are preferably linearly calculated for the sake of simplicity, although more complex smoothing can be alternatively performed without departing from the teachings of the present invention. LCU boundary interpolation follows a similar set of steps to smooth a number of pixels about the periphery of each block, such as an LCU. Interpolation at the LCU boundary generally has maximum distance d such as between 2 to 6, and more preferably 4.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic of a video encoder according to an embodiment of the present invention.

FIG. 2 is a schematic of a video decoder according to an embodiment of the present invention.

FIG. 3 is a graph of four band offset values showing interpolation according to an embodiment of the present invention.

FIG. 4 is a graph of linear interpolation at a band boundary to a depth d, according to an embodiment of the present invention.

FIG. 5 is a diagram of an LCU block showing boundary interpolation according to an embodiment of the present invention.

FIG. 6 is a graph of linear LCU boundary interpolation to a depth d, according to an embodiment of the present invention.

FIG. 7 is a flow diagram of a boundary interpolation method for band offset (BO) within an SAO filter according to an embodiment of the present invention.

### DETAILED DESCRIPTION OF THE INVENTION

The inventive SAO filter boundary interpolation (BI) method can be implemented in an encoding system (encoder and decoder) as described in the following paragraphs.

In considering BO offsets for the SAO filter, the current HEVC specification does not restrict the magnitude of the difference between neighboring offsets; only the value of each individual offset is restricted to +/−16 in 8 bit pictures. This magnitude is sufficiently large to introduce strong edges, as the derivative can be as large as 32. Use of the inventive boundary interpolation (BI) to the band offsets according to the invention eliminates these edge problems.

It should also be noted that in HEVC, offsets are applied only to the current LCU, and not likely to the next ones, whereby it is beneficial to perform a similar boundary interpolation (BI) to the LCU boundary.

The SAO boundary interpolation (BI) mechanisms are described below within an encoder and decoder, respectively.

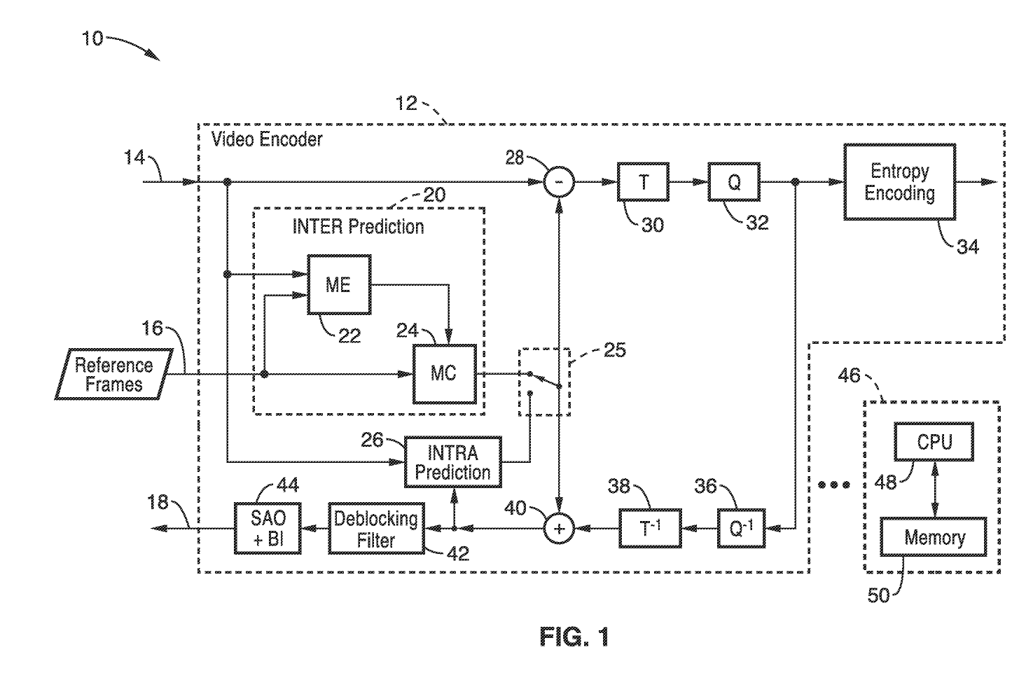

FIG. 1 illustrates an example embodiment of a coding apparatus comprising an encoder 10 according to the invention for performing boundary interpolation (BI) within sample adaptive offsets (SAO) following the deblocking filter.

The encoder 10 is shown with encoding elements 12 executed by a computing means 46 exemplified with one or more processors 48, along with one or more memory devices 50. It will be appreciated that elements of the present invention can be implemented as programming stored on a media, which can be accessed for execution by a CPU for an encoder and/or decoder.

In the example, video frame input 14 is shown along with reference frames 16 and frame output 18. Inter-prediction 20 is depicted with motion estimation (ME) 22 and motion compensation (MC) 24. Intra-prediction 26 is shown with switching 25 depicted between inter-prediction and intra-prediction. A sum junction 28 is shown with output to a forward transform 30 which is performed based on the predictions to generate transform coefficients of residual data. Quantization of the transform coefficients is performed at quantization stage 32, which is followed by entropy encoding 34. Inverse quantization 36 and inverse transform 38 operations are shown coupled to a summing junction 40.

Output of summing junction 40, is a decoded video signal which is received by a deblocking filter 42, then a boundary interpolation (BI) sample adaptive offset (SAO) filter 44 according to the present invention, to produce an output 18.

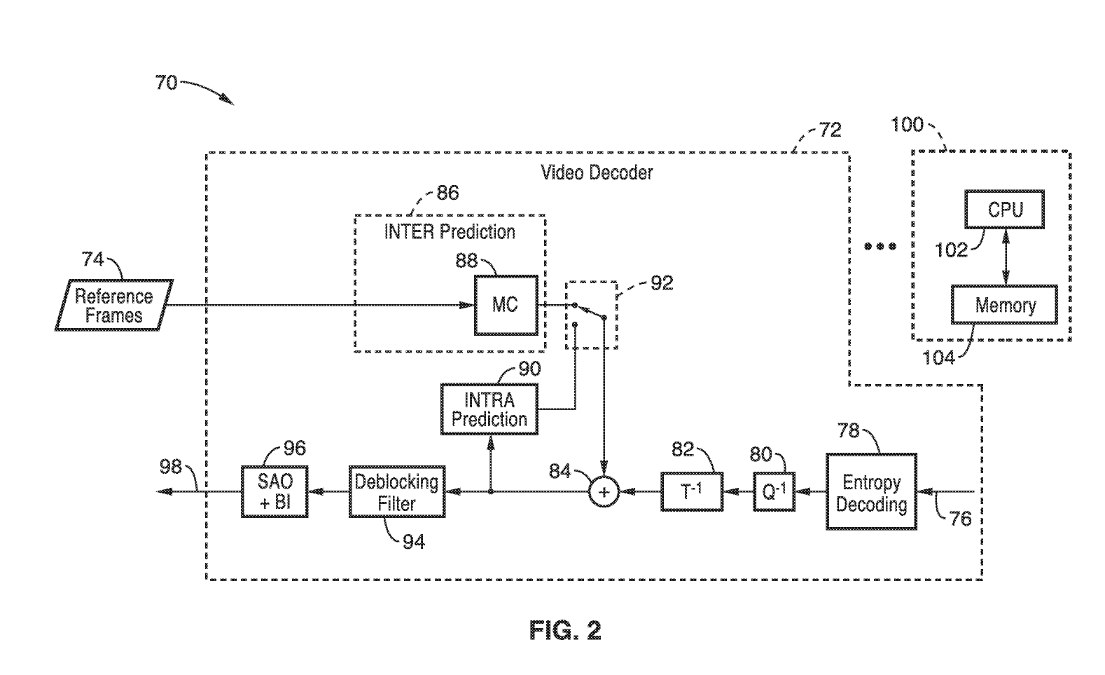

FIG. 2 illustrates an example embodiment 70 of a decoder, shown with process blocks 72 and an associated processing means 102. It will be noted that the decoder is substantially a subset of the elements contained in encoder 10 of FIG. 1, operating on reference frames 74 and outputting video signal 98. The decoder receives an encoded video signal 76 which is processed through entropy decoder 78, inverse quantization 80, inverse transform 82, and summing 84 between the inverse transform 82 output and the selection 92 between inter-prediction 86 shown with motion compensation 88 and a separate intra-prediction block 90. Output from summing junction 84 is received by a deblocking filter 94, followed by SAO filter with boundary interpolation (BI) 96 according to the present invention to produce a video output 98.

It should be appreciated that the decoder can be implemented with a processing means 100 which comprises at least one processing device 102 and at least one memory 104 for executing programming associated with the decoding. In addition, it will be noted that elements of the present invention can be implemented as programming stored on a media, wherein said media can be accessed for execution by processing device (CPU) 102.

It will be recognized that elements of the present invention 10 and 70 are implemented for execution by a processing means 46 and 100, such as in response to programming resident in memory 50 and 104 which is executable on computer processor (CPU) 48 and 102. In addition, it will be appreciated that elements of the present invention can be implemented as programming stored on a media, wherein said media can be accessed for execution by CPU 48 and/or 102.

It should also be appreciated that the above programming is executable from the memory which is a tangible (physical) computer readable media that is non-transitory in that it does not merely constitute a transitory propagating signal, but is actually capable of retaining programming, such as within any desired form and number of static or dynamic memory devices. These memory devices need not be implemented to maintain data under all conditions (e.g., power fail) to be considered herein as non-transitory media.

To understand BI for BO, it will be recognized that HEVC working draft 6 (WD6) divides the entire intensity range into 32 bands. The encoder selects 4 bands, out of the 32, for which it transmits band offsets. Each offset is individually restricted to +/−16 in 8 bit pictures. Each offset sent spans a number of the 32 bands, such as 4 bands per offset sent with the remaining bands being considered zero. It should be appreciated, that pixels whose values are originally close, but are placed at different sides of the band boundary can end up with offset values which are far apart after the SAO process is performed. Compounding the issue, pixels with similar intensity values usually are also spatially close, especially in areas which are smooth, wherein the artificial edges produced by the limitations of current band offset techniques are especially noticeable. Attempting to limit offset differences at the encoder can slightly reduce the problem, yet introduces coding efficiency losses since the best offset value cannot be selected.

The present invention solves this artificial edge problem by performing an interpolation operation (e.g., linear for sake of simplicity) toward smoothing band boundaries, without the need of changing the original offset values. Although, any form of interpolative smoothing may be utilized according to the invention, for the sake of simplicity of illustration, the example embodiment describes a linear smoothing using linear interpolation at the boundary.

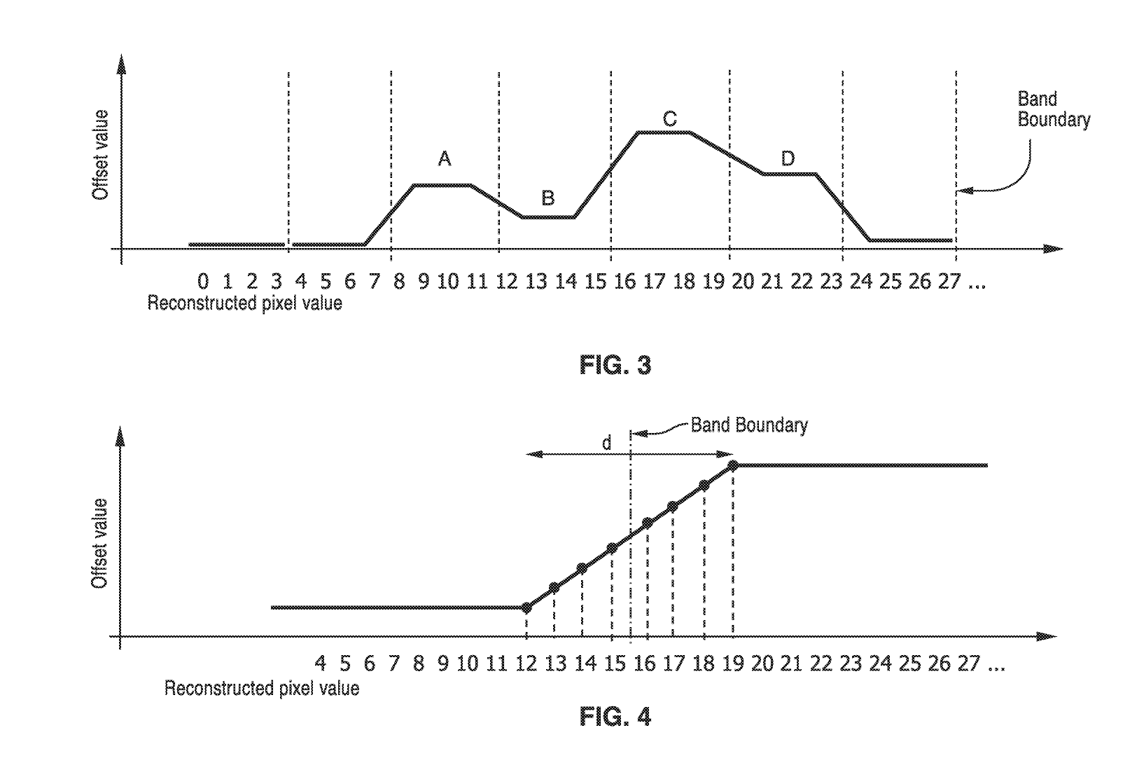

FIG. 3 illustrates boundary interpolation (BI) for band offsets in the SAO filter according to the invention. It can be seen in the figure, that although there are still only 4 offsets transmitted, depicted as plateaus A, B, C and D, significant discontinuities between similar pixel values are eliminated in response to the interpolations, seen as linear slopes, smoothly interconnecting each of the four offset plateaus.

According to this method, a non-zero offset may be applied to some pixels that belong to bands for which the encoder has not sent any offsets, such as pixels with intensities 7 and 24 in FIG. 3. The linear smoothing process has a parameter d which is the maximum number of pixels at the boundary that can be assigned an offset different from their original offset value.

FIG. 4 illustrates the concept of boundary interpolation for a boundary width d. Let, O₀ and O₁ indicate the two offsets for the left and right side band, respectively. Then, the offset for the i^{th} (i∈{0, 1, 2, . . . , d, d+1}) pixel from the left to right is obtained according to:

$$O ( i ) = \frac{1}{{2}^{D}} [ ( {O}_{1} - {O}_{0} ) \frac{i \times {2}^{D}}{d + 1} ] + {O}_{0} \qquad ( 1 )$$

where D is the bit precision that enables an integer multiplication and shift operation instead of a division. Trivially, for the two values i=0 and i=d+1 we get the original values O₀ and O₁, respectively, as expected. It will be noted that since both D and dare known and fixed, the division in equation (1) above can be performed offline and rounded to the closest integer for each value i. For typical values of d=4 (two pixels on each side) and D=2, D=4, and D=8, the coefficients i×2^{D}/d+1 are listed in Table 1.

Interpolation at the band boundary generally has maximum distance d, such as between 4 to 10, and more preferably 6 or 8, as the distance between the two values that have their original offset value.

Similar problems can arise at partition boundaries arising between largest coding units (LCU), whereby the periphery (boundary region) between one LCU can have different offsets from the next LCU, resulting in a discontinuity at the boundary area.

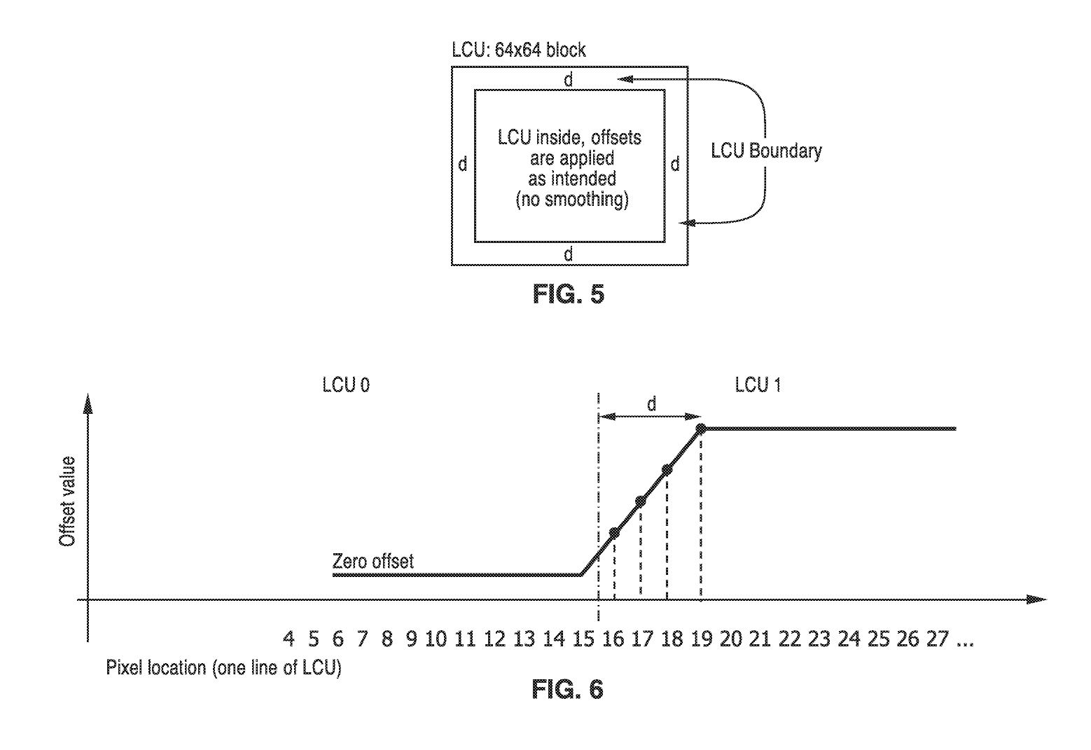

FIG. 5 depicts an LCU boundary of width d. It should be appreciated that the LCU boundary zone is interpolated with the offset outside of the LCU projected to be zero. To reduce the artifacts due to this LCU type of discontinuity, if the LCU is not merged to a neighboring LCU, the offsets for pixels in the LCU (or partition) boundary are derived (e.g., linearly) according to the invention, from the original offset and zero. It is assumed that the offset value at distance d from the boundary is the same as its original value O, but outside the partition it is zero. A simple linear equation may be utilized according to the invention, such as similar to equation (1), whereby pixel values in the partition boundaries (e.g., picture, slice or LCU) are computed. The invention provide interpolation of the filtering applied to these boundaries to prevent discontinuity from one block to another.

In FIG. 6 it is seen that LCU 0 (on the left) is assumed to have a zero offset, while LCU 1 has a significant offset. The boundary of LCU 1 is thus interpolated according to the invention to provide a smooth offset transition between LCU 0 and LCU 1. These steps can be generally summarized as: (i) computing values in LCU partition boundary, (ii) assuming adjacent LCU boundaries have zero offset; and (iii) interpolation of filtering applied to said partition boundary to provide a smooth transition sloping toward a zero offset at boundary with adjacent LCU boundary.

Interpolation at the LCU boundary generally has a maximum distance d for LCU boundary interpolation, such as between 2 to 6, and more preferably 4. In a preferred embodiment these offset are linearly calculated for the sake of simplicity.

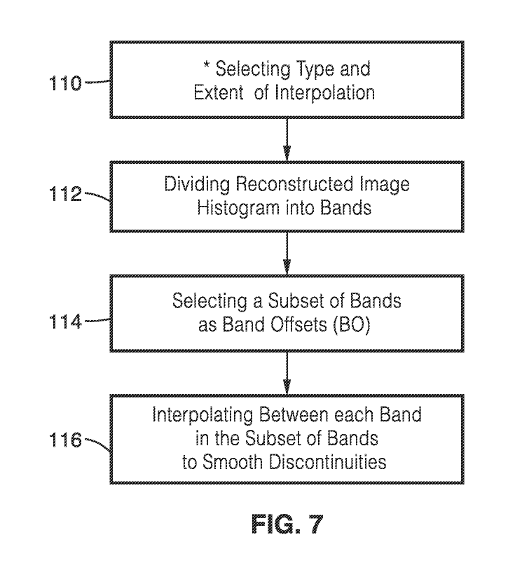

FIG. 7 illustrates the general boundary interpolation method for band offsets. An optional step 110 is shown for selecting/determining the type and extent of interpolation. This step is optional, as the type and extent may be fixed, such as using a linear interpolation with a fixed distance d into the band offsets. Alternatively, one could choose other types of interpolation or different extents, insofar as the decoder was also configured to know the type and extent. In step 112 the reconstructed image histogram is divided into a plurality of bands, and a subset of bands is selected 114, from these plurality of bands for transmission as band offsets. An interpolation is performed 116 between each of these subset of bands within the plurality of bands to create a smooth transition area between each of said subset of bands. It will be noted that the interpolation of the selected bands is performed at the boundaries between bands when any discontinuity exists, such as between adjacent non-zero bands and between non-zero bands and zero bands.

It will be appreciated that FIG. 7 also applies when performing boundary interpolations based on picture, slice and LCUs; because the adjacent block, such as LCU, is assumed to have a zero offset, wherein the edges of the current block are interpolated to smooth the transition between blocks. If the adjacent LCU also has an offset, then the interpolation performed at the boundary of that block would similarly smooth that edge to presuming its neighbor has a zero offset.

Embodiments of the present invention were tested assuming d=4 in band boundary smoothing (for 8 bit images), resulting in modifying the offsets for two pixel values on each side of the boundary. Similarly, for the case of LCU smoothing, the offset for two pixels in the boundary of the LCU were modified. The bit-depth precision was set to 8, however, a 4 bit precision will result in similar results (difference is in the second digits).

Both objective and subjective results were determined as described in the following paragraphs. Objective results were determined with CE1 anchors and test condition is followed to obtain results shown in Tables 2 and 3. Table 2 lists results obtained for band boundary interpolation, while Table 3 lists results obtained for a combination of band boundary interpolation and LCU boundary interpolation. Each of these tables contains four sections (1) Random Access Main, (2) Low delay B Main with CU as 64×64, (3) 32×32, and (4) 16×16, with each table section including results of an HE10 (high efficiency test condition) variant.

To obtain subjective results, in response to human perception, the reconstructed videos from a software containing both band and LCU smoothing methods were studied and compared with CE1 anchors. In order to make a fair comparison between the proposed method and the reference, factors other than SAO were made as similar as possible. This is because if the rate-distortion optimization (RDO) takes a slightly different route, the resulting videos may appear very different in areas of a frame, while on the average the performance seen would be similar. As a result, in the present study, the only focus was on Intra coding structure so that the reconstructed picture before SAO are exactly the same for every picture and the differences observed are thus due to SAO only.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

From the discussion above it will be appreciated that the invention can be embodied in various ways, including the following:

1. An apparatus for sample adaptive offset (SAO) signaling during video entropy encoding, comprising: (a) a video encoder configured for receiving a video signal, said video encoder including a processor; (b) programming executable on said processor and configures for: (i) receiving a decoded video signal having a reconstructed image histogram from a deblocking filter of said video encoder; (ii) dividing the reconstructed image histogram into a plurality of bands; (iii) selecting a subset of bands of these plurality of bands for transmission as band offsets (BO); and (iv) interpolating between each of said subset of bands within said plurality of images to create a smooth transition area between each of said subset of bands within said plurality of bands.

2. The apparatus of any of the previous embodiments, wherein said programming is configured to perform boundary interpolation (BI) between each band offset (BO) to a predetermined number of pixels.

3. The apparatus of any of the previous embodiments, wherein said predetermined number of pixels comprises a value d for band offsets which is set between 4 to 10.

4. The apparatus of any of the previous embodiments, wherein said predetermined number of pixels comprises a value d for band offsets which is set to either 6 or 8.

5. The apparatus of any of the previous embodiments, wherein said programming is configured to perform boundary interpolation (BI) to a predetermined number of pixels at an LCU boundary.

6. The apparatus of any of the previous embodiments, wherein said predetermined number of pixels is given by a value d for LCU boundaries set at between 2 to 6.

7. The apparatus of any of the previous embodiments, wherein said predetermined number of pixels is given by a value d for LCU boundaries set at 4.

8. The apparatus of any of the previous embodiments, wherein said boundary interpolation (BI) is performed using linear interpolation.

9. The apparatus of any of the previous embodiments, further comprising programming executable on said processor for performing boundary interpolation (BI) to largest coding units (LCUs), by: (i) computing values in LCU partition boundary; (ii) assuming adjacent LCU boundaries have zero offset; and (iii) interpolation of filtering applied to said partition boundary to provide a smooth transition sloping toward a zero offset at boundary with adjacent LCU boundary.

10. The apparatus of any of the previous embodiments, wherein said video encoder comprises a video encoder utilizing a high efficiency video coding (HEVC) standard.

11. An apparatus for sample adaptive offset (SAO) signaling during video entropy encoding, the apparatus comprising: (a) a video encoder configured for receiving a video signal, said video encoder including a processor; (b) programming executable on said processor for: (i) receiving a decoded video signal having a reconstructed image histogram from a deblocking filter of said video encoder; (ii) dividing the reconstructed image histogram into a plurality of bands; (iii) selecting a subset of bands of these plurality of bands for transmission as band offsets (BO); (iv) interpolating between each of said subset of bands within said plurality of images to create a smooth transition area between each of said subset of bands within said plurality of bands; and (v) interpolating around the perimeter of each LCU boundary to create a smooth transition area between each LCU.

12. The apparatus of any of the previous embodiments, wherein said programming is configured to perform boundary interpolation (BI) between each band offset (BO) to a predetermined maximum number of pixels.

13. The apparatus of any of the previous embodiments, wherein said predetermined maximum number of pixels comprises a value d, set for band offsets between 4 to 10.

14. The apparatus of any of the previous embodiments, wherein said predetermined maximum number of pixels comprises a value d, set for band offsets to either 6 or 8.

15. The apparatus of any of the previous embodiments, wherein said programming is configured to perform interpolation around the perimeter of each LCU to a predetermined maximum number of pixels.

16. The apparatus of any of the previous embodiments, wherein said predetermined maximum number of pixels is given by a value d set for LCU boundaries between 2 to 6.

17. The apparatus of any of the previous embodiments, wherein said predetermined maximum number of pixels is given by a value d set at 4.

18. The apparatus of any of the previous embodiments, wherein said interpolation for both band offsets (BO) and LUC boundaries is a linear interpolation.

19. The apparatus of any of the previous embodiments, further comprising programming executable on said processor for interpolating at an LCU boundary, in response to: (i) computing values in LCU partition boundary; (ii) assuming adjacent LCU boundaries have zero offset; and (iii) interpolation of filtering applied to said partition boundary to provide a smooth transition sloping toward a zero offset at boundary with adjacent LCU boundary.

20. A method of performing sample adaptive offset (SAO) filtering within a video entropy encoder, the method comprising: (a) receiving a decoded video signal having a reconstructed image histogram from a deblocking filter of a video encoder receiving a video signal processed by programming executing on a computer processor within said video encoder; (b) dividing the reconstructed image histogram into a plurality of bands; (c) selecting a subset of bands of these plurality of bands for transmission as band offsets (BO); and (d) interpolating between each of said subset of bands within said plurality of images to create a smooth transition area between each of said subset of bands within said plurality of bands.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Integer Coefficient Values for Different Bit-Precisions

| (i × 2^{D}/d + 1) | i = 1 | i = 2 | i = 3 | i = 4 |
|---|---|---|---|---|
| D = 2 | 1 | 2 | 2 | 3 |
| D = 4 | 3 | 6 | 10 | 13 |
| D = 8 | 51 | 102 | 154 | 205 |

TABLE 2
Results for Band Boundary Interpolation

| | Random Access Main | | | Random Access HE10 | | |
|---|---|---|---|---|---|---|
| | Y | U | V | Y | U | V |
| Class A | 0.1% | 0.4% | 0.2% | 0.1% | 0.0% | 0.2% |
| Class B | −0.1% | −0.2% | −0.1% | 0.0% | 0.0% | 0.1% |
| Class C | −0.1% | −0.3% | −0.2% | −0.1% | 0.0% | 0.0% |
| Class D | −0.4% | −0.5% | −0.4% | −0.3% | −0.4% | −0.4% |
| Class E | | | | | | |
| Overall | −0.1% | −0.1% | −0.1% | −0.1% | −0.1% | 0.0% |
| | −0.1% | −0.2% | −0.1% | −0.1% | −0.1% | 0.0% |
| Class F | −0.1% | 0.0% | 0.0% | −0.1% | 0.0% | 0.1% |

| Enc Time[%] | 100% | | | 100% | | |
|---|---|---|---|---|---|---|
| Dec Time[%] | 100% | | | 99% | | |
| | Low delay B Main CU64x64 | | | Low delay B HE10 CU64x64 | | |
| | Y | U | V | Y | U | V |
| Class A | | | | | | |
| Class B | 0.0% | 0.1% | 0.0% | 0.0% | 0.0% | 0.0% |
| Class C | 0.0% | −0.1% | −0.1% | 0.0% | −0.2% | −0.1% |
| Class D | 0.0% | −0.1% | 0.0% | −0.1% | −0.2% | −0.3% |
| Class E | −0.1% | −0.3% | −0.3% | 0.0% | 0.1% | 0.0% |
| Overall | 0.0% | −0.1% | 0.0% | 0.0% | −0.1% | −0.1% |
| | 0.0% | −0.1% | 0.0% | 0.0% | −0.2% | −0.1% |
| Class F | −0.2% | −0.4% | −0.3% | −0.1% | 0.2% | −0.2% |

| | | |
|---|---|---|
| Enc Time[%] | 98% | 98% |
| Dec Time[%] | 101% | 103% |

| | Low delay B Main CU32x32 | | | Low delay B HE10 CU32x32 | | |
|---|---|---|---|---|---|---|
| | Y | U | V | Y | U | V |
| Class A | | | | | | |
| Class B | 0.0% | −0.1% | −0.5% | 0.0% | 0.0% | 0.1% |
| Class C | 0.0% | −0.2% | −0.1% | 0.0% | 0.1% | 0.0% |
| Class D | 0.0% | −0.1% | −0.1% | 0.0% | −0.3% | −0.7% |
| Class E | −0.1% | 0.1% | 0.1% | 0.0% | 0.0% | −0.1% |
| Overall | 0.0% | −0.1% | −0.2% | 0.0% | 0.0% | −0.2% |
| | 0.0% | −0.1% | −0.2% | 0.0% | 0.0% | −0.1% |
| Class F | −0.3% | 1.2% | 0.4% | 0.0% | −0.4% | 0.1% |
| | Low delay B Main CU16x16 | | | Low delay B HE10 CU16x16 | | |
| | Y | U | V | Y | U | V |
| Class A | | | | | | |
| Class B | −0.1% | −0.2% | 0.1% | 0.0% | −0.1% | 0.4% |
| Class C | 0.0% | −0.1% | 0.2% | 0.0% | −0.1% | 0.1% |
| Class D | 0.0% | 0.1% | 0.2% | 0.0% | 0.4% | −0.2% |
| Class E | 0.0% | 0.2% | 0.1% | 0.0% | 0.1% | −0.1% |
| Overall | 0.0% | 0.0% | 0.1% | 0.0% | 0.0% | 0.1% |
| | 0.0% | 0.0% | 0.1% | 0.0% | 0.0% | 0.1% |
| Class F | −0.2% | 0.2% | −0.9% | 0.0% | 0.3% | 0.8% |

TABLE 3
Results for Combination of Band and LCU Boundary Smoothing

| | Random Access Main | | | Random Access HE10 | | |
|---|---|---|---|---|---|---|
| | Y | U | V | Y | U | V |
| Class A | 0.1% | 0.4% | 0.2% | 0.0% | −0.2% | −0.4% |
| Class B | −0.1% | −0.2% | −0.1% | 0.0% | 0.0% | 0.1% |
| Class C | −0.1% | −0.3% | −0.2% | 0.0% | 0.0% | 0.1% |
| Class D | −0.4% | −0.5% | −0.4% | 0.0% | 0.0% | 0.0% |
| Class E | | | | | | |
| Overall | −0.1% | −0.1% | −0.1% | 0.0% | −0.1% | 0.0% |
| | −0.1% | −0.2% | −0.1% | 0.0% | −0.1% | 0.0% |
| Class F | −0.1% | 0.0% | 0.0% | 0.0% | 0.0% | 0.2% |

| | | |
|---|---|---|
| Enc Time[%] | 100% | 100% |
| Dec Time[%] | 99% | 100% |

| | Low delay B Main CU64x64 | | | Low delay B HE10 CU64x64 | | |
|---|---|---|---|---|---|---|
| | Y | U | V | Y | U | V |
| Class A | | | | | | |
| Class B | 0.0% | 0.1% | 0.0% | 0.0% | −0.2% | −0.1% |
| Class C | 0.0% | 0.1% | 0.2% | 0.0% | 0.0% | 0.1% |
| Class D | 0.0% | 0.2% | 0.7% | 0.0% | −0.5% | −0.3% |
| Class E | 0.0% | 0.1% | 0.0% | 0.1% | 0.2% | 0.1% |
| Overall | 0.0% | 0.1% | 0.3% | 0.0% | −0.2% | −0.1% |
| | 0.0% | 0.1% | 0.3% | 0.0% | −0.2% | −0.2% |
| Class F | −0.1% | 0.2% | 0.3% | −0.1% | 0.5% | −0.2% |

| | | |
|---|---|---|
| Enc Time[%] | 99% | 99% |
| Dec Time[%] | 102% | 102% |

| | Low delay B Main CU32x32 | | | Low delay B HE10 CU32x32 | | |
|---|---|---|---|---|---|---|
| | Y | U | V | Y | U | V |
| Class A | | | | | | |
| Class B | 0.0% | 0.2% | −0.3% | 0.0% | 0.1% | 0.2% |
| Class C | 0.0% | 0.2% | 0.1% | 0.0% | 0.2% | 0.2% |
| Class D | −0.1% | −0.1% | 0.1% | 0.0% | 0.3% | −0.1% |
| Class E | 0.0% | −0.1% | −0.3% | 0.1% | 0.2% | −0.4% |
| Overall | 0.0% | 0.1% | −0.1% | 0.0% | 0.2% | 0.0% |
| | 0.0% | 0.1% | −0.1% | 0.0% | 0.2% | 0.0% |
| Class F | −0.2% | 0.4% | 0.3% | 0.0% | −0.3% | 1.0% |
| | Low delay B Main CU16x16 | | | Low delay B HE10 CU16x16 | | |
| | Y | U | V | Y | U | V |
| Class A | | | | | | |
| Class B | 0.0% | −0.1% | 0.3% | 0.0% | −0.3% | 0.0% |
| Class C | 0.0% | 0.0% | −0.1% | −0.1% | −0.2% | 0.2% |
| Class D | −0.1% | −0.2% | −0.5% | 0.0% | 0.3% | 0.1% |
| Class E | 0.0% | 0.3% | 0.1% | 0.0% | −0.1% | −0.1% |
| Overall | 0.0% | 0.0% | 0.0% | 0.0% | −0.1% | 0.1% |
| | 0.0% | 0.0% | 0.0% | 0.0% | −0.1% | 0.1% |
| Class F | 0.0% | −0.1% | −0.4% | 0.0% | 0.5% | 0.8% |

What is claimed is:

1. An apparatus for sample adaptive offset (SAO) signaling during video entropy encoding, the apparatus comprising:
(a) a video encoder configured for receiving a video signal, said video encoder including a processor; and
(b) programming executable on said processor and configured for:
(i) receiving a decoded video signal having a reconstructed image histogram from a deblocking filter of said video encoder;
(ii) dividing the reconstructed image histogram into a plurality of bands;
(iii) selecting a subset of bands of these plurality of bands for transmission as band offsets (BO); and
(iv) interpolating between each of said subset of bands within said plurality of images to create a smooth transition area between each of said subset of bands within said plurality of bands.

2. The apparatus recited in claim 1, wherein said programming is configured to perform boundary interpolation (BI) between each band offset (BO) to a predetermined number of pixels.

3. The apparatus recited in claim 2, wherein said predetermined number of pixels comprises a value a for band offsets which is set between 4 to 10.

4. The apparatus recited in claim 2, wherein said predetermined number of pixels comprises a value a for band offsets which is set to either 6 or 8.

5. The apparatus recited in claim 1, wherein said programming is configured to perform boundary interpolation (BI) to a predetermined number of pixels at an LCU boundary.

6. The apparatus recited in claim 5, wherein said predetermined number of pixels is given by a value a for LCU boundaries set at between 2 to 6.

7. The apparatus recited in claim 5, wherein said predetermined number of pixels is given by a value a for LCU boundaries set at 4.

8. The apparatus recited in claim 5, wherein said boundary interpolation (BI) is performed using linear interpolation.

9. The apparatus recited in claim 5, further comprising programming executable on said processor for performing boundary interpolation (BI) to largest coding units (LCUs), by:
(i) computing values in LCU partition boundary,
(ii) assuming adjacent LCU boundaries have zero offset; and
(iii) interpolation of filtering applied to said partition boundary to provide a smooth transition sloping toward a zero offset at boundary with adjacent LCU boundary.

10. The apparatus recited in claim 1, wherein said video encoder comprises a video encoder utilizing a high efficiency video coding (HEVC) standard.

11. An apparatus for sample adaptive offset (SAO) signaling during video entropy encoding, the apparatus comprising:
(a) a video encoder configured for receiving a video signal, said video encoder including a processor; and
(b) programming executable on said processor and configured for:
(i) receiving a decoded video signal having a reconstructed image histogram from a deblocking filter of said video encoder;
(ii) dividing the reconstructed image histogram into a plurality of bands;
(iii) selecting a subset of bands of these plurality of bands for transmission as band offsets (BO); and
(iv) interpolating between each of said subset of bands within said plurality of images to create a smooth transition area between each of said subset of bands within said plurality of bands; and
(v) interpolating around the perimeter of each LCU boundary to create a smooth transition area between each LCU.

12. The apparatus recited in claim 1, wherein said programming is configured to perform boundary interpolation (BI) between each band offset (BO) to a predetermined maximum number of pixels.

13. The apparatus recited in claim 12, wherein said predetermined maximum number of pixels comprises a value a, set for band offsets between 4 to 10.

14. The apparatus recited in claim 12, wherein said predetermined maximum number of pixels comprises a value a, set for band offsets to either 6 or 8.

15. The apparatus recited in claim 11, wherein said programming is configured to perform interpolation around the perimeter of each LCU to a predetermined maximum number of pixels.

16. The apparatus recited in claim 15, wherein said predetermined maximum number of pixels is given by a value a set for LCU boundaries between 2 to 6.

17. The apparatus recited in claim 15, wherein said predetermined maximum number of pixels is given by a value d set at 4.

18. The apparatus recited in claim 11, wherein said interpolation for both band offsets (BO) and LUC boundaries is a linear interpolation.

19. The apparatus recited in claim 11, further comprising programming executable on said processor for interpolating at an LCU boundary, in response to:
(i) computing values in LCU partition boundary;
(ii) assuming adjacent LCU boundaries have zero offset; and
(iii) interpolation of filtering applied to said partition boundary to provide a smooth transition sloping toward a zero offset at boundary with adjacent LCU boundary.

20. A method of performing sample adaptive offset (SAO) filtering within a video entropy encoder, the method comprising:
(a) receiving a decoded video signal having a reconstructed image histogram from a deblocking filter of a video encoder receiving a video signal processed by programming executing on a processor within said video encoder;
(b) dividing the reconstructed image histogram into a plurality of bands;
(c) selecting a subset of bands of these plurality of bands for transmission as band offsets (BO); and
(d) interpolating between each of said subset of bands within said plurality of images to create a smooth transition area between each of said subset of bands within said plurality of bands.
